(19) United States
(12) Patent Application Publication
(10) Pub. No.: US 2024/0049920 A1
(43) Pub. Date: Feb. 15, 2024

(54) TONGS FOR TURNING OVER FOOD

(71) Applicant: Heeseop KIM, Toseong-myeon, Goseong-gun Gangwon-do (KR)

(72) Inventor: Heeseop KIM, Toseong-myeon, Goseong-gun Gangwon-do (KR)

(21) Appl. No.: 18/257,747

(22) PCT Filed: Oct. 11, 2022
(86) PCT No.: PCT/KR2022/015313

§ 371 Date: Jun. 15, 2023

(30) Foreign Application Priority Data
Oct. 18, 2021 (KR) 10-2021-0138581

(51) Int. Cl. A47J 43/28

(52) U.S. Cl. CPC A47J 43/283

(57) ABSTRACT

Proposed are tongs for turning over food. More particularly, proposed are tongs, in which food is turned over as a first tong body and a second tong body are closed toward the food. The first tong body is provided with a first grasping portion having a half-ring shape with an open longitudinal section, and a second tong body is provided with a second grasping portion for pushing the food up along a curved surface of the first grasping portion, so that food between the tongs is rotated and turned over due to the internal structure of the tongs as the tongs are closed toward the food.

### TECHNICAL FIELD

The present disclosure relates generally to tongs. More particularly, the present disclosure relates to tongs, in which foods with a thin and wide shape, such as meat patties, fish filets, and pancakes, between the tongs are rotated and turned over due to the internal structure of the tongs as the tongs are closed toward the foods.

### BACKGROUND ART

In general, tongs are a type of tool used to grasp objects. They usually have two arms with grasping ends, and are designed to handle objects that are difficult to hold with bare hands by closing the arms. In home kitchen, tongs are often used to grasp and turn over food in a hot pan to ensure even heating.

With tongs, the user can turn over the food by rotating the tongs by turning the wrist while grasping the food with the tongs. However, it takes a lot of time to grasp and turn over a large amount of foods one by one, so there is a possibility that the food that is turned over late may be burned.

In an effort to solve this problem, Korean Utility Model Registration No. 20-0355265 (hereinafter referred to as “cited invention”) discloses, as illustrated in FIG. 1, a structure in which a first turner plate and a second turner plate serving as upper and lower tongs are formed in a wide plate shape to grasp and turn over a plurality of foods simultaneously.

However, since this method requires the user to turn the wrist to turn food over after grasping it, the user may injure the wrist when heating a large amount of foods or when continuously turning foods over. Also, these tongs have a limited ability to grasp and turn over thin and wide foods such as meat patties, mini pork cutlets, and pork belly.

### DISCLOSURE

### Technical Problem

Accordingly, the present disclosure has been made keeping in mind the above problems occurring in the related art, and an objective of the present disclosure is to provide tongs, in which food is turned over as a first tong body and a second tong body are closed toward the food. The first tong body is provided with a first grasping portion having a half-ring shape with an open longitudinal section, and a second tong body is provided with a second grasping portion for pushing the food up along a curved surface of the first grasping portion.

### Technical Solution

In order to accomplish the above objective, the present disclosure provides tongs including: a first tong body provided with a first grasping portion at a first end thereof; and a second tong body provided with a second grasping portion at a first end thereof to correspond to the first grasping portion. Here, the first grasping portion and the second grasping portion may be closed toward food located therebetween, the first grasping portion may be formed in a half-ring shape with a longitudinal section open toward the second grasping portion, and the second grasping portion may push the food up along an inner curved surface of the first grasping portion as the first tong body and the second tong body are closed.

Furthermore, the first grasping portion may be made of an elastic material.

Furthermore, the second grasping portion may have an inclined surface facing the inner curved surface of the first grasping portion while forming an acute angle with a horizontal plane.

Furthermore, the second grasping portion may have a support surface provided below the inclined surface and pushing the food up along the inner curved surface of the first grasping portion.

Furthermore, the first tong body and the second tong body may respectively include a first handle portion and a second handle portion extending upward from the first grasping portion and the second grasping portion, respectively. Here, the first handle portion and the second handle portion may be formed to form an obtuse angle with the first grasping portion and the second grasping portion, respectively.

### Advantageous Effects

According to the present disclosure, as a first grasping portion having a half-ring shape and a second grasping portion having a support surface for pushing food up are closed, the second grasping portion pushes the food up along the curved surface of the first grasping portion and turns the food over. Thus, a user can easily turn over the food by closing a first tong body and a second tong body without the need for turning the wrist.

In addition, the user can turn over thin and wide foods, such as meat patties, mini pork cutlets, and pork belly, through a simple action of grasping the food.

### DESCRIPTION OF DRAWINGS

FIG. 1 is a view illustrating the related art.

FIG. 2 is a perspective view illustrating a front structure of tongs according to an embodiment of the present disclosure.

FIG. 3 is an exemplary view illustrating a side structure of the tongs according to the embodiment of the present disclosure.

FIG. 4 is an exemplary view illustrating a front structure of the tongs according to the embodiment of the present disclosure.

FIGS. 5 to 10 are exemplary views illustrating the operation of the tongs according to the embodiment of the present disclosure.

FIGS. 11 to 14 are exemplary views illustrating the operation of the tongs provided with a first grasping portion made of an elastic material, according to the embodiment of the present disclosure.

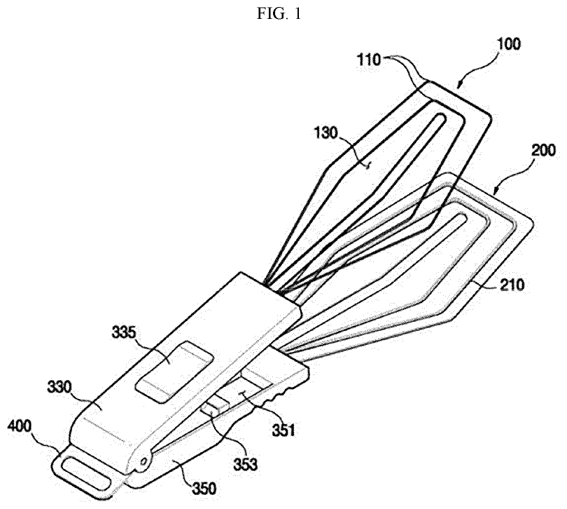

### MODE FOR INVENTION

The present disclosure provides tongs, in which food is turned over as a first tong body and a second tong body are closed toward the food. The first tong body is provided with a first grasping portion having a half-ring shape with an open longitudinal section, and the second tong body is provided with a second grasping portion for pushing the food up along an inner curved surface of the first grasping portion.

The scope of the present disclosure is not limited to embodiments described below, and various modifications can be made by those skilled in the art within the scope of the technical gist of the present disclosure.

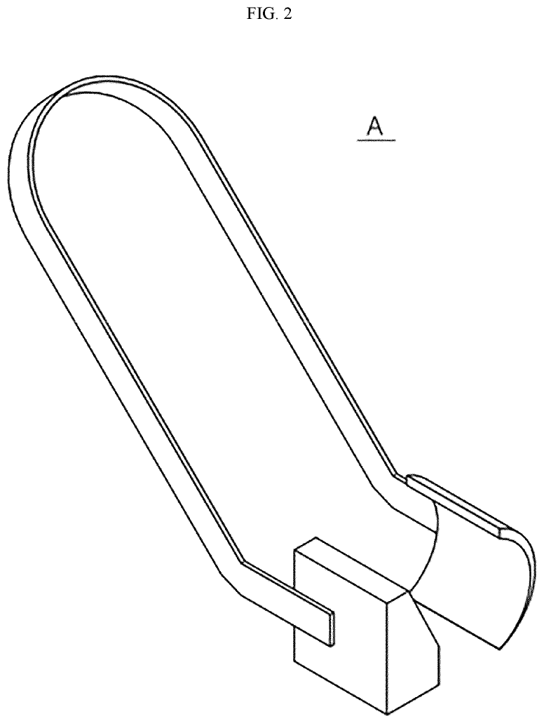

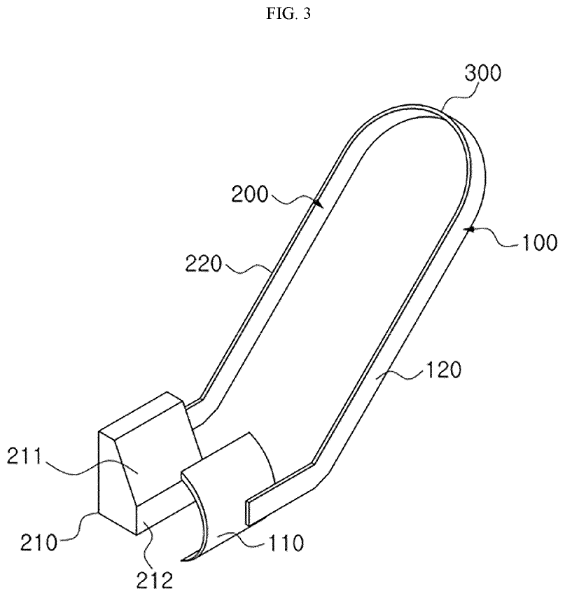

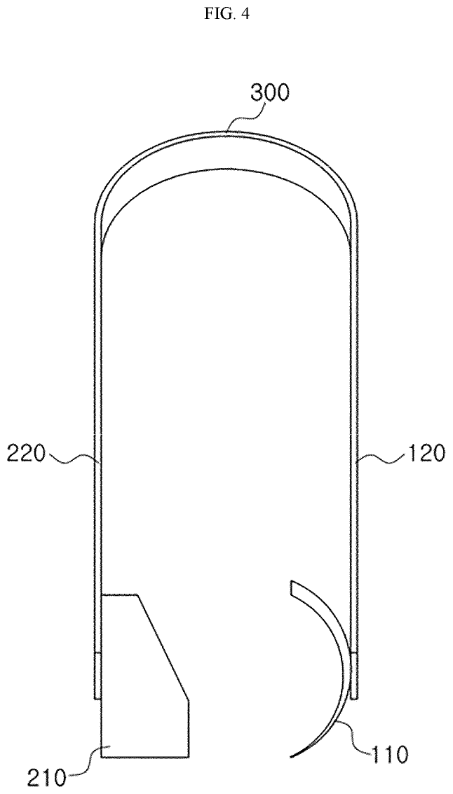

As illustrated in FIGS. 2 to 4, tongs A according to the present disclosure include a first tong body 100 provided with a first grasping portion 110 at a first end thereof and a second tong body 200 provided with a second grasping portion 210 at a first end thereof to correspond to the first grasping portion 110. In addition, the first tong body 100 and the second tong body 200 respectively include a first handle portion 120 and a second handle portion 220 extending upward from the first grasping portion 110 and the second grasping portion 210, respectively.

As illustrated in FIGS. 2 to 4, the first tong body 100 is provided with the first grasping portion 110 formed in a half-ring shape at the first end thereof. The first tong body 100 includes the first handle portion 120 extending from the first grasping portion 110 while forming an obtuse angle with the first grasping portion 110. The first tong body 100 is formed parallel to the second tong body 200, and a second thereof is elastically connected to a second end of the second tong body 200.

A connector 300 disposed between the second end of the first tong body 100 and the second end of the second tong body 200 connects the second end of the first tong body 100 and the second end of the second tong body 200 to each other. The connector 300 has a semi-circular shape with an open bottom and is made of an elastic material so that the first tong body 100 and the second tong body 200 are elastically restored to a parallel shape after being closed by an external force. Here, the connector may be formed in a “U” shape with an open bottom.

As illustrated in FIGS. 2 to 4, the second tong body 200 is provided with the second grasping portion 210 at the first end thereof. The second grasping portion 210 has an inclined surface 211 forming an acute angle with a horizontal plane, and a support surface 212 provided below the inclined surface 211 and pushing food 10 toward the first grasping portion 110. The second tong body 200 includes the second handle portion 220 extending from the second grasping portion 210 and forming an obtuse angle with the second grasping portion 210.

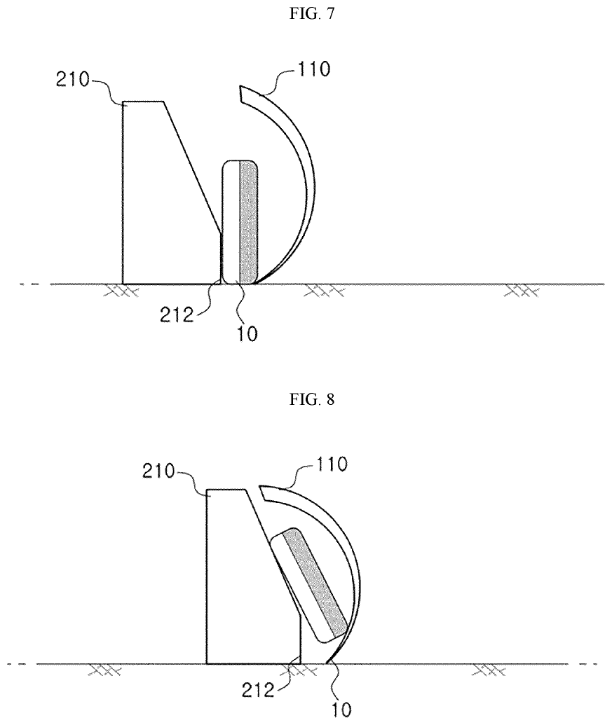

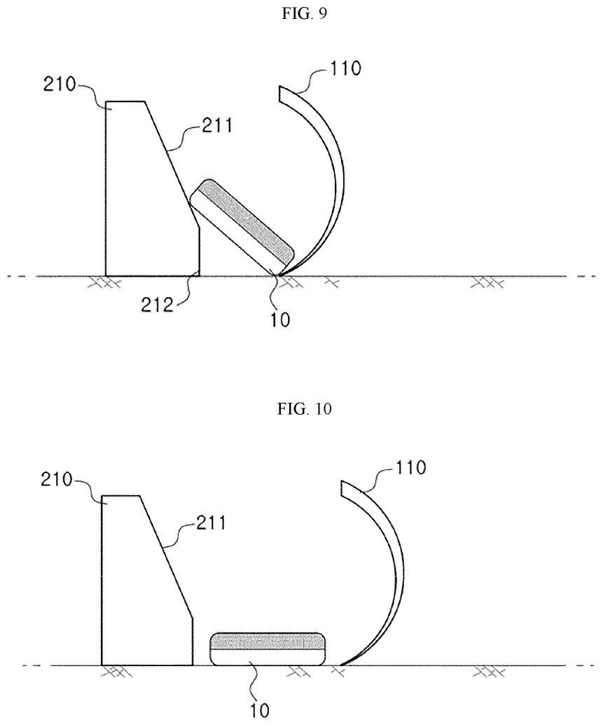

As illustrated in FIGS. 2 to 10, the first grasping portion 110 is provided at the first end of the first tong body 100, is formed larger in size than the food 10 in the longitudinal direction, and is formed in a half-ring shape open toward the second grasping portion 210 facing the first grasping portion 110. Here, a lower end of the first tongs 110 in contact with a bottom surface may have a thickness smaller than that of an upper end thereof so that the food 10 pushed from the second grasping portion 210 is pushed up along an inner curved surface of the first grasping portion 110.

In addition, the shape of the first grasping portion 110 may include a semi-elliptical shape open toward the second grasping portion 210. The inner side of the first grasping portion 110 facing the second grasping portion 210 may be formed in a shape with a curved surface so that the food 10 is rotated along the inner curved surface as the first grasping portion 110 is closed in correspondence with the second grasping portion 120. However, the shape of the inner side of the first grasping portion 110 is not limited to specific shapes.

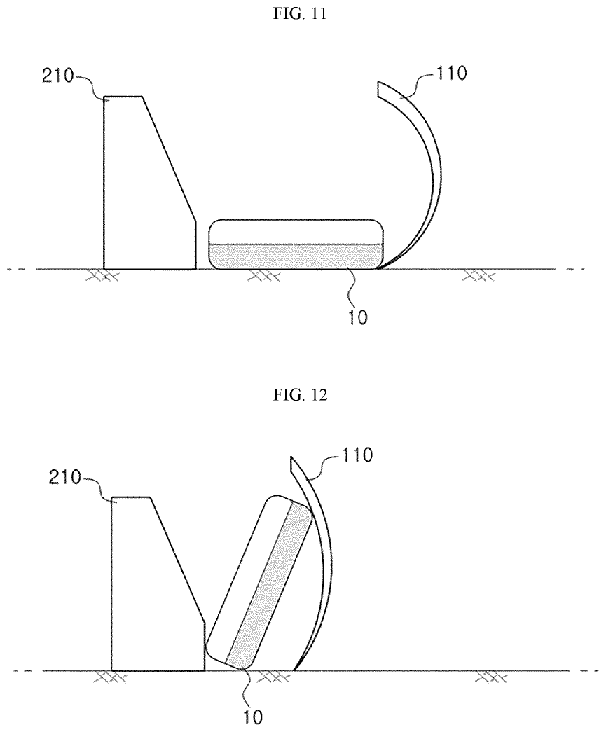

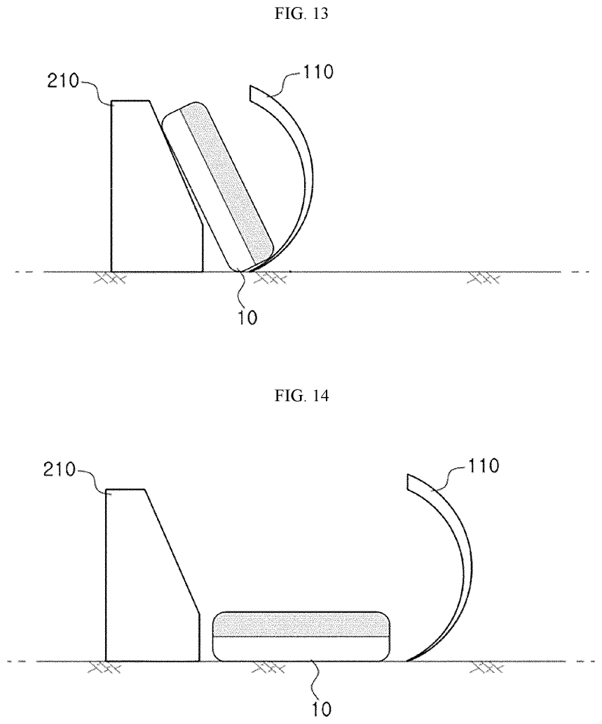

Here, the first tongs 110 may be made of an elastic material. Thus, as illustrated in FIGS. 11 to 14, when the food 10 is pushed up along the inner curved surface of the first grasping portion 110 through the second grasping portion 210, the first grasping portion 110 is deformed according to the size or shape of the food 10 to cause the food 10 being pushed up is dropped, while preventing the food 10 from being compressed or broken and preventing the food 10 from escaping out of the tongs through an elastic force returning to its original shape.

As illustrated in FIGS. 2 to 14, the second grasping portion 210 has the inclined surface 211 facing the inner curved surface of the first grasping portion 110 while forming an acute angle with the horizontal plane, and the support surface 212 provided below the inclined surface 211 and pushing up the food 10 located between the first tong body 110 and the second tong body 210 along the inner curved surface of the first grasping portion 110 as the first grasping portion 110 and the second grasping portion 210 are closed. Here, the support surface 212 may be formed in a shape with a height greater than that of the food 10 and may be formed orthogonal to the horizontal plane.

As illustrated in FIGS. 2 to 4, the first handle portion 120 is formed to extend upward from the first grasping portion 110 while forming an obtuse angle with the first grasping portion 110. The second handle portion 220 is formed to extend upward from the second grasping portion 210 while forming an obtuse angle with the second grasping portion 210. Here, a grip may be formed on each of the handle portions so that a user can easily hold the tongs by the grip. The grip may be made of various types of materials including plastic or wood to prevent heat from the tongs from being transmitted to the user.

The operation of the tongs A according to the present disclosure will be described in detail with reference to FIGS. 5 to 14. The tongs A including the first tong body 100 and the second tong body 200 is manipulated so that the first grasping portion 110 and the second grasping portion 210 are closed toward the food 10 located between the first grasping portion 110 and the second grasping portion 210.

In detail, when the user using the tongs holds the first handle portion 120 and the second handle portion 220 and applies an external force to bring the first grasping portion 110 and the second grasping portion 210 into contact with each other, as illustrated in FIG. 5, the food 10 is pushed by the support surface 212 of the second grasping portion 210 formed orthogonal to the food 10 and higher than the food 10 and is easily moved toward the inner curved surface of the first grasping portion 110 having the thin lower end.

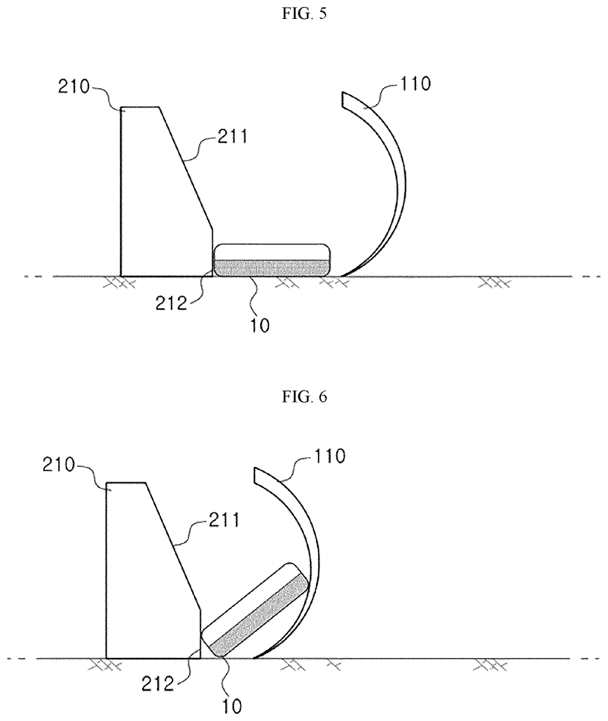

Then, as illustrated in FIGS. 6 to 10, as the first grasping portion 110 and the second grasping portion 210 are closed, the food 10 located between the first grasping portion 110 and the second grasping portion 210 is pushed by the support surface 212 and lifted along the inner curved surface of the first grasping portion 110. As the first grasping portion 110 and the second grasping portion 210 are further closed, the food 10 is rotated while being supported on the inclined surface 211 of the second grasping portion 210.

Here, when the user removes the external force applied to the tongs A, as the closed first grasping portion 110 and second grasping portion 210 are returned to their original positions by the elastic force of the connector 300 connecting the first tong body 100 and the second tong body 200, the food 10 supported on the inclined surface 211 of the second grasping portion 210 is dropped downward and placed on the bottom surface in a rotated state from its original state.

For example, in a case where the tongs A according to the embodiment of the present disclosure is used to rotate a plurality of foods having a thin and wide shape such as a plurality of mini pork cutlets placed on a frying pan, when the user places the tongs A so that the food is located between the first grasping portion 110 and the second grasping portion 210 and simply presses the tongs A, the food is pushed up along the inner curved surface of the first grasping portion 110 by the support surface 212 of the second grasping portion 210 and supported on the inclined surface 211 of the second grasping portion 210. When the user releases the tongs A, the food supported by the inclined surface 211 of the second grasping portion 210 is dropped to the bottom of the frying pan and turned over.

In addition, as illustrated in FIGS. 11 to 14, in a case where the tongs A are used to rotate a large-sized food 10 or a hard food 10, the food 10 is pushed up against the first grasping portion 110 through the support surface 212 of the second grasping portion 210. As illustrated in FIG. 12, as the food 10 pushed up through the support surface 212 is rotated along the inner curved surface of the elastic first grasping portion 110, the inner curved surface of the first grasping portion 110 is elastically deformed, causing the food 10 to be rotated.

### DESCRIPTION OF THE REFERENCE NUMERALS IN THE DRAWINGS

A: tongs 10: food
100: first tong body 110: first grasping portion
120: first handle portion
200: second tong body 210: second grasping portion
211: inclined surface 212: support surface
220: second handle portion
300: connector

1. Tongs comprising:
a first tong body (100) provided with a first grasping portion (110) at a first end thereof; and
a second tong body (200) provided with a second grasping portion (210) at a first end thereof to correspond to the first grasping portion (110),
wherein the first grasping portion (110) and the second grasping portion (210) are closed toward food (10) located therebetween, the first grasping portion (110) is formed in a half-ring shape with a longitudinal section open toward the second grasping portion (210), and the second grasping portion (210) is configured to push the food (10) up along an inner curved surface of the first grasping portion (110) as the first tong body (100) and the second tong body (200) are closed.

2. The tongs of claim 1, wherein the first grasping portion (110) is made of an elastic material.

3. The tongs of claim 1, wherein the second grasping portion (210) has an inclined surface (211) facing the inner curved surface of the first grasping portion (110) while forming an acute angle with a horizontal plane.

4. The tongs of claim 3, wherein the second grasping portion (210) has a support surface (212) provided below the inclined surface (211) and pushing configured to push the food (10) up along the inner curved surface of the first grasping portion (110).

5. The tongs of claim 1, wherein the first tong body (100) and the second tong body (200) respectively include a first handle portion (120) and a second handle portion (220) extending upward from the first grasping portion (110) and the second grasping portion (210), respectively, and
wherein the first handle portion (120) and the second handle portion (220) are formed to form an obtuse angle with the first grasping portion (110) and the second grasping portion (210), respectively.
